(19) United States
(12) Patent Application Publication
(10) Pub. No.: US 2026/0338131 A1
(43) Pub. Date: Oct. 29, 2026

(54) PISTON FOR AN INTERNAL COMBUSTION ENGINE AND METHOD FOR ITS PRODUCTION

(71) Applicant: FEDERAL-MOGUL NÜRNBERG GMBH, NURNBERG (DE)

(72) Inventors: Ralf MESKE, Schwabach (DE); Michael SCHERER, Fürth (DE)

(21) Appl. No.: 19/107,186

(22) PCT Filed: Aug. 29, 2023
(86) PCT No.: PCT/EP2023/073620

§ 371 Date: Feb. 27, 2025

(30) Foreign Application Priority Data
Sep. 1, 2022 (DE) 10 2022 209 095.0

(51) Int. Cl. F02F 3/22

(52) U.S. Cl. CPC F02F 3/22

(57) ABSTRACT

A piston for use in internal combustion engines is provided. The piston has a piston crown, an annular cooling channel, and two of each of skirt and box walls adjoining the piston crown. One skirt wall each extends between two box walls, and the box walls have pin bores configured to receive gudgeon pins. The cooling channel has inlets and outlets for coolant. In the region of the inlets and outlets for coolant, at least one flat support extends between an outer wall of the pin bore and the adjacent skirt walls. The support contains the respective inlet and outlet and a surface of the support facing away from the piston crown has a largely flat portion extending substantially in the radial direction with respect to the central axis of the pin bore.

### CROSS REFERENCE TO RELATED APPLICATIONS

This U.S. patent application is a national phase entry of PCT Patent Application No. PCT/EP2023/073620, filed 29 Aug. 2023, which claims priority to German Patent Application No. DE 10 2022 209 095.0, filed 1 Sep. 2022, the entire contents of which are incorporated herein by reference in their entirety.

### BACKGROUND

### 1. Technical Field

The present invention relates to a piston for use in internal combustion engines and a method for its production.

### 2. Related Art

Pistons are used in internal combustion engines to convert the thermal energy of fuel combustion into mechanical energy in order to propel a vehicle. The pistons are therefore used in an environment in which they are exposed to high pressures as well as high temperatures. For modern and efficient diesel engines, steel pistons are currently designed for pressures of 250 to 300 bar. Such pistons require a piston geometry that can withstand these loads with an acceptable stress distribution and without plastic deformation and has high structural durability. High stresses occur particularly in the area where the force is conducted from the piston crown to the piston boss, the so-called block support. Furthermore, a bore near the block support is required to cool the piston via the annular cooling channel, which introduces a further concentration of stress in this already highly loaded area.

Usually, the fillet radius in the block support between the pin eye and the lower edge of the cooling channel is increased if the stress concentration impairs the strength of the piston too much. Sufficient strength cannot always be achieved with an increase in radius, as the installation space in the area of the inlet and outlet bore of the cooling channel is limited and an increase in radius is not the most efficient design modification for stress reduction.

Prior art describing pistons is described in WO 2017/102 252 A1, DE 3 917 755 C2, DE 10 2007 018 932 A1, DE 10 2018 109 205 A1, DE 10 2019 204 559 A1, DE 10 2020 007 484 A1 and US D886 155 S.

### SUMMARY

The inventors have found that a specific configuration of the piston in the area of the block support results in increased strength and dissipates the stresses particularly efficiently. The invention is defined by the independent claims. Preferred embodiments are described in the respective dependent claims.

According to claim 1, a piston for use in internal combustion engines has a piston skirt and two skirt and box walls each, which are alternately arranged along the circumference of the piston such that two skirt walls each enclose a box wall (and, accordingly, two box walls each enclose a skirt wall). While the skirt wall typically follows the outer contour of the piston, the box walls are somewhat set back. Owing to the position of the connecting rod, different lateral forces act on the two skirt walls. The side that is loaded in the working stroke is designated as the pressure side and the opposite side as the counterpressure side.

Pin bores are provided in the box walls, which are configured to receive gudgeon pins, i.e. into which such gudgeon pins can be inserted. Typically, these pin bores have a round cross-section, possibly with a shaped bore, and are therefore largely cylindrical in shape. The axis of the pin bore can intersect the cylinder axis at one point, but can also have a certain distance from it, the so-called pin offset. The outer wall of the pin bore, i.e. the wall that encloses the pin bore, is designated as the pin eye.

The inventors have found that due to the sliding contact between the pin and the pin bore, essentially only normal forces can be transmitted from the piston to the pin, which means that the flow of force must be in the radial direction onto the pin bore. Due to the ovalization of the pin, the maximum of the contact stresses in the pin bore is at a certain angle β to the apex of the pin bore, which depends on the ignition pressure and the pin geometry. Usual values for β are between 30° and 60°. In a conventional configuration with a fillet radius on the block support between the pin eye and the lower edge of the cooling channel, the radial force flow is disturbed and a critical stress concentration occurs at higher ignition pressures.

According to the invention, the transition between a pin eye and the lower edge of the cooling channel is formed at least at one point by a flat support, which is preferably located in the area of the inlet and/or outlet of the cooling channel on the pressure side of the piston. The flat support extends between the outer wall of the pin bore and the associated skirt wall. The support has a largely flat portion on the surface facing away from the piston crown. According to the invention, this largely flat portion extends substantially in a radial direction with respect to the cylindrical surface of the pin bore. The support is limited towards the connecting rod swivel plane by a further surface, which is essentially a continuation of the surface above the piston boss.

Compared to DE 10 2019 204 559 A1, the configuration according to the invention differs by a flat support containing the bore of the cooling channel inlet instead of a rib placed next to the cooling channel inlet. This shape is better suited to the forging manufacturing process, as the material can flow better and less wear is generated on the forging die.

It is preferred that the largely flat portion extends substantially in a radial direction forming an angle α of 50° to 70°, preferably 60°, to the apex of the pin bore. Such a piston exhibits a significant reduction in stress and therefore has a greatly improved service life.

Preferably, the flat portion of the support transitions via a radius into the skirt wall and/or the lower edge of the cooling channel and via a further radius into the pin eye. The two radii can be selected independently of each other.

Optionally, the flat portion of the support can deviate from the radial direction and be offset parallel to it by a certain amount, namely by up to ±5% of the piston diameter.

The piston according to the invention has a cooling channel that is provided below the piston crown. Such a cooling channel is typically annular in shape and is formed, for example, by welding together an upper and a lower part. As a welding process, friction welding can be used. However, other welding processes are also conceivable. The cooling channel can also be produced using salt cores (e.g. for aluminum pistons). The cooling channel has inlets and outlets for coolant, which is typically oil. The coolant is injected through the inlet, then flows through the cooling channel and exits the outlet, thereby cooling the piston. The inlets and outlets are arranged in the space enclosed by the skirt and box walls. At least one, preferably both, of the inlets and outlets is formed in the area of the flat support, which means that the flat support forms part of the enclosure of the inlet and/or outlet. Such a configuration has proven to be particularly useful for reasons of structural durability.

The position of the cooling channel outlet can be freely selected. By contrast, the position of the cooling channel inlet is determined by the position of the oil spray nozzle. If this is located too far in the direction of the connecting rod swivel plane of the piston, the wall thickness of the reinforcing rib is reduced and a further concentration of stress occurs. Therefore, a minimum wall thickness of 40% to 60% of the diameter of the bore of the cooling channel inlet is preferred.

If the installation space is severely restricted by a wide connecting rod, the wall thickness in the area of the cooling channel inlet may be selected to be lower than the minimum wall thickness. Local thickening in the normal direction can be used to compensate for the stress concentration at the apex of the edge line between the inlet bore and the flat support. This local thickening should be 10% to 20% of the diameter of the inlet bore at the apex and should transition in a tangentially constant manner into the contour of the flat support at the distance of the radius of the inlet bore. With very high ignition pressures, the measures of minimum wall thickness and local thickening can be combined. This leads to a particularly effective stress reduction in the area of the cooling channel inlet.

Furthermore, it is preferred that the geometric shape of the flat support can be demolded inwards along the pin axis. This leads to better manufacturability.

Furthermore, a method of producing a piston as described above is in accordance with the invention. Here, at least one of the inlets and outlets is formed by drilling starting from the cooling channel to be formed. By drilling the inlet and outlet of the cooling channel from the side of the cooling channel, the exit surface does not have to be planar and can therefore be optimally configured to absorb the flow of force. This provides increased flexibility in the design of the piston.

### BRIEF DESCRIPTION OF THE DRAWINGS

FIG. 1 shows a sectional view through a piston according to a first embodiment of the invention in a section perpendicular to the pin bore.

FIG. 2 shows a bottom view of the piston of FIG. 1.

FIG. 3 shows a detailed view of an outlet of the cooling channel of the piston of FIG. 1.

FIG. 4 shows the piston of FIG. 1 in an oblique view.

FIG. 5 shows a detailed view of the outlet of the cooling channel of the piston of FIG. 1.

FIG. 6 shows a detailed view of the support according to the first embodiment.

FIG. 7 shows a detailed view of the support according to the second embodiment.

FIGS. 8 to 15 show simulation results for an exemplary embodiment of a piston according to the prior art and the present invention.

### DETAILED DESCRIPTION OF EXAMPLE EMBODIMENTS

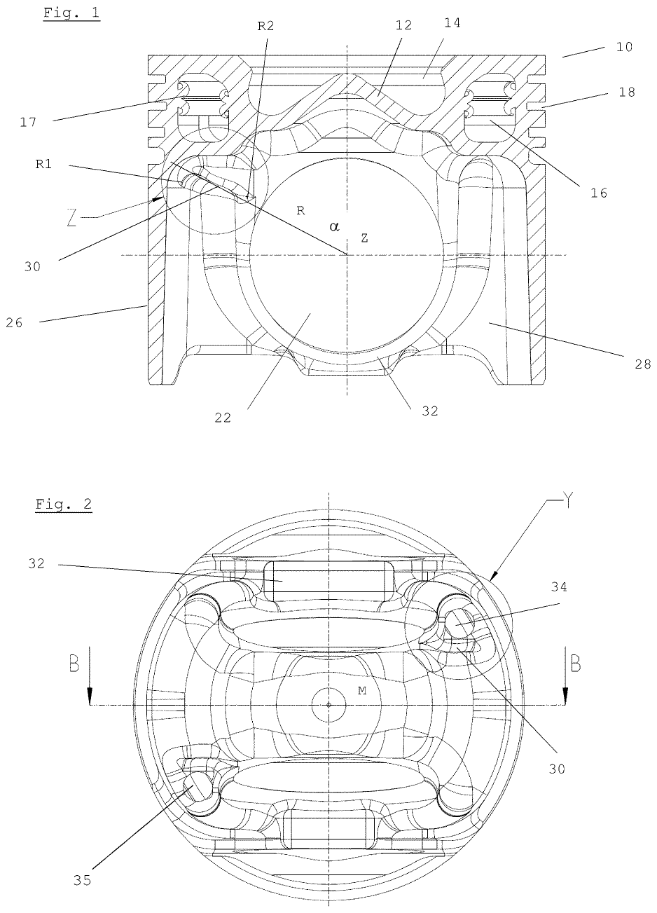

In the following, a first embodiment of the invention is described with reference to FIGS. 1 to 6.

FIG. 1 shows a sectional view of a piston 10 according to an embodiment of the invention. The piston 10, which in the present case is formed by welding two components together, has a piston crown 12 which contains a combustion chamber cavity 14. An annular cooling channel 16 is provided radially outside the combustion chamber cavity 14, within which weld beads 17 extend as artifacts due to the production method of the piston 10. Further radially outwards on the radial outer side of the piston, a ring zone 18 is provided to receive piston rings.

The piston 10 has skirt walls 26 and box walls 28. The box walls 28 each have a pin bore 22 with an enclosure 32. The pin bore 22 is essentially cylindrical in shape, with the center M of the bore lying in a plane which is offset by a pin offset d from the plane containing the central axis of the piston 10.

The enclosure 32 of the pin bore 22 is connected to the associated skirt wall 26 via a flat support 30. The flat support 30 has a flat portion 31 (see FIG. 5), i.e. a portion that is not or not significantly curved. As can be seen from FIG. 1, this portion extends along a radial direction R, which extends radially from the center Z of the pin bore 22 to the outer side of the skirt wall 26. The flat portion 31 transitions with two radii of curvature R1, R2 into the enclosure 32 of the pin bore 22 (radius R1) and into the skirt wall 26 (radius R2).

Here, the angle α between the radius R and the axial direction of the piston is in the range of 50° to 70° and is preferably 60°. This has proven to be particularly advantageous for the stability of the piston and the reduction of stresses.

FIG. 2 shows a bottom view of the piston shown in FIG. 1. Here, FIG. 1 is a section along the line B-B of FIG. 2. It can be seen how an outlet 34 for the cooling channel 16 is formed. An inlet 35 is arranged approximately diagonally opposite. A similar view is shown in FIG. 4. It can also be seen here that the flat support 30 extends in an essentially flat manner, i.e. only slightly curved.

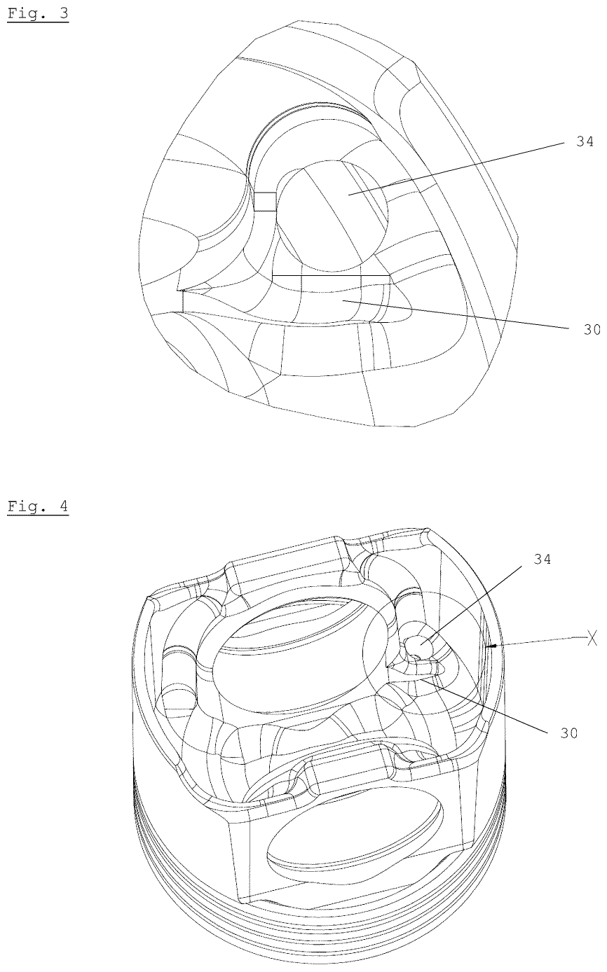

FIG. 3 shows a further detailed view, which can be seen as a top view of the detail Z of FIG. 2. Here, too, it can be seen how the flat support 30 forms part of the enclosure of the outlet of the cooling channel 34 and adjoins the enclosure 32 of the pin bore 22.

FIG. 5 shows a further detailed view of the outlet 34 shown in FIG. 3. It can be seen from the figure that the flat support 30 has a material thickness in the direction of the pin bosses in the range of 40% to 60% of the diameter of the associated inlet 34.

FIG. 6 shows the flat support 30 of the piston 10 according to the first embodiment of the invention in detail. It can be seen from the figure that a large part of the surface of the support extends in an essentially flat manner.

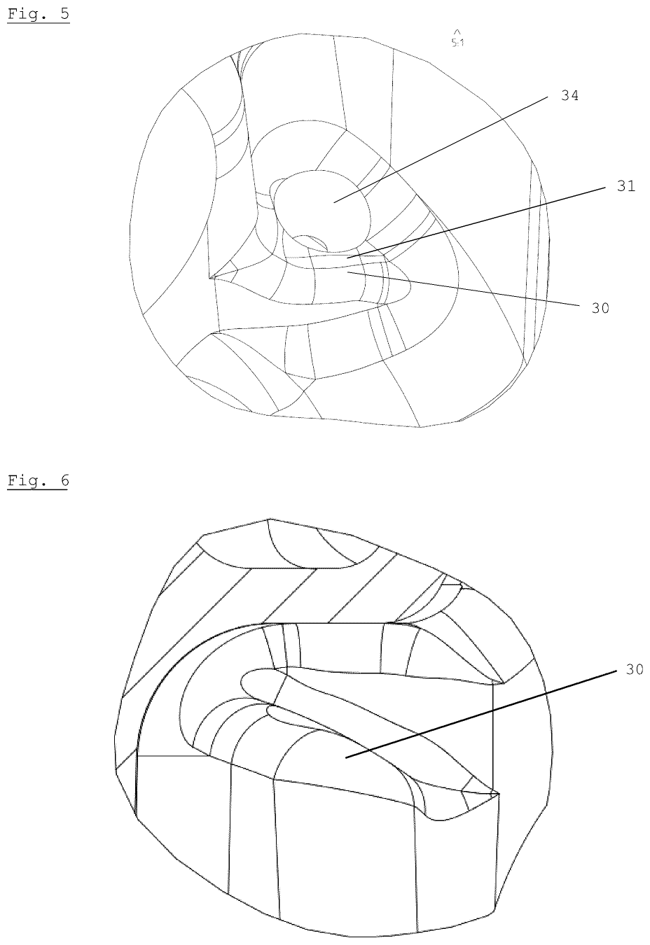

FIG. 7 shows the flat support 30′ in a piston according to a second embodiment of the invention. The details of the piston are otherwise identical to the piston according to the first embodiment. It can be seen in FIG. 7 that a thickening 34′ (thickening) is provided on the essentially planar flat support 30′. Such a thickening 34′ leads to a further reduction in stress within the piston material.

A flat support is understood here to be a material protrusion extending in a rib-like manner, the surface of which is at least partially planar, i.e. flat. The inlet for the cooling channel is not set back from this surface, but intersects it.

A largely flat curve is defined as a curve that deviates from a completely flat curve by a maximum of 10% in the axial direction of the piston.

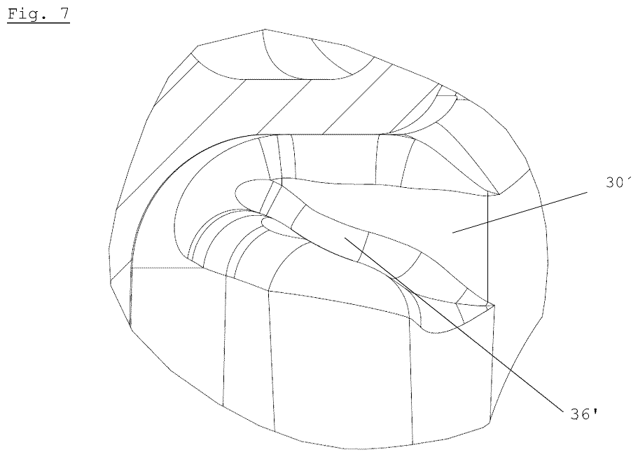

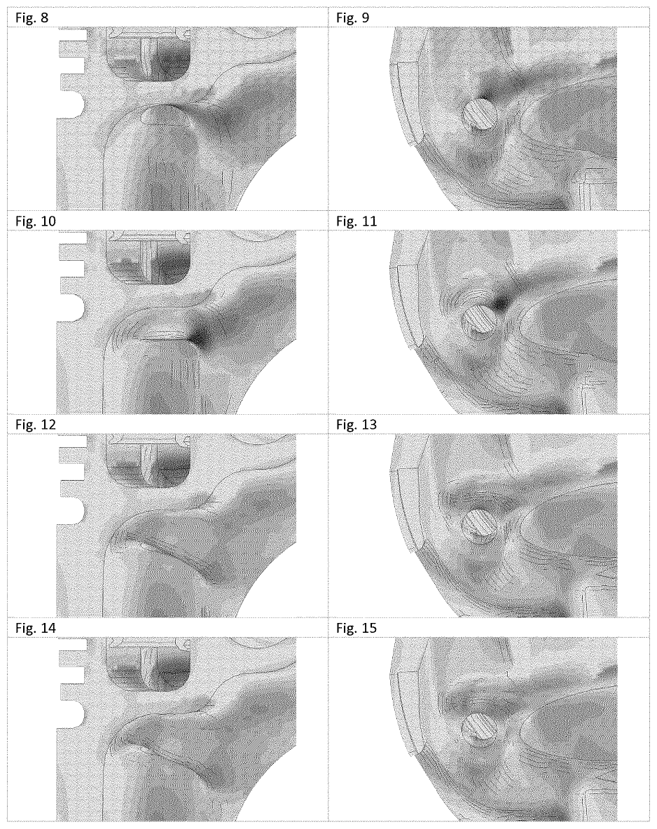

The invention was analyzed using extensive finite element simulations. FIGS. 8 to 15 show the amplitude stress for the structural durability calculation for different geometric variants of an exemplary piston, each with the same scaling and in two different views.

FIGS. 8 and 9 show a piston according to the prior art. The highest stress (designated here as 100% reference value) occurs at the cooling channel inlet. An engineering improvement with a circumferential reinforcement (see FIGS. 10 and 11) moderately reduces the stress to 92% and shifts the position of the maximum into the radius between the pin eye and the circumferential reinforcement. Only the flat support according to the invention with integrated cooling channel inlet according to FIGS. 12 and 13 results in a significant stress reduction to 71%, the position of the maximum again being at the apex of the cooling channel inlet.

A further reduction to 54% is achieved by the local thickening according to the invention in the normal direction at the apex (see FIGS. 14 and 15), whereby the stress at the edge line of the inlet is equalized and thus lowered.

What is claimed is:

1. A piston for use in internal combustion engines, the piston having a piston crown, an annular cooling channel, a ring zone, and two of each of skirt and box walls adjoining the piston crown,
wherein the box walls have pin bores configured to receive gudgeon pins,
wherein the cooling channel has an inlet and an outlets for coolant, and
wherein, in the region of at least one of the inlet and the outlets for coolant, at least one flat support extends between an outer wall of the pin bore and the adjacent skirt walls, which support contains the respective inlet and outlet and whose surface facing away from the piston crown has a largely flat portion extending substantially in the radial direction with respect to the central axis of the pin bore.

2. The piston according to claim 1, wherein the largely flat portion extends substantially in a radial direction with respect to the central axis of the pin bore, and the angle between a tangential plane onto the flat support and a plane through the central axis of the pin bore and the apex of the pin bore is between 50° and 70°.

3. The piston according to claim 1, wherein the flat portion transitions via a radius into the skirt wall and/or via a further radius into the outer wall of the pin bore.

4. The piston according to claim 1, wherein the flat portion is arranged parallel to a radial direction within a range of ±5% of the piston diameter.

5. The piston according to claim 1, wherein at least one of the inlet and the outlet has an enclosure having a minimum wall thickness in the range of 40% to 60% of the diameter of the associated inlet and outlet.

6. The piston according to claim 1, wherein at least one of the inlet and the outlet has a local thickening in the normal direction at the apex, which is 10% to 20% of the diameter of the respective bore and transitions in a tangentially constant manner into the contour of the flat support.

7. The piston according to claim 1, wherein the piston is a steel piston.

8. A method for producing a piston according to claim 1, wherein at least one of the inlet and the outlet is formed by drilling starting from the cooling channel.

9. The piston according to claim 2, wherein the angle between the tangential plane onto the flat support and the plane through the central axis of the pin bore and the apex of the pin bore is 60°.

10. The piston according to claim 5, wherein both the inlet and the outlet have the enclosure having the minimum wall thickness in the range of 40% to 60% of the diameter of the associated inlet and outlet.

11. The piston according to claim 6, wherein both the inlet and the outlet have the local thickening in the normal direction at the apex.
